(19) United States
(12) Patent Application Publication
(10) Pub. No.: US 2023/0294568 A1
(43) Pub. Date: Sep. 21, 2023

(54) ASSEMBLY FOR A SLIDABLE VEHICLE SEAT

(71) Applicant: AUDI AG, Ingolstadt (DE)

(72) Inventors: Dirk ECKENROTH, Eitensheim (DE); Mario GABBERT, Ingolstadt (DE); Christian NEUFELDT, Langenbrettach (DE)

(73) Assignee: AUDI AG, Ingolstadt (DE)

(21) Appl. No.: 18/042,831

(22) PCT Filed: Sep. 23, 2021
(86) PCT No.: PCT/EP2021/076186

§ 371 Date: Feb. 24, 2023

(30) Foreign Application Priority Data
Oct. 20, 2020 (DE) 102020127529.3

(51) Int. Cl. B60N 2/07; B60N 2/015

(52) U.S. Cl. CPC B60N 2/0715; B60N 2/0722; B60N 2/015

(57) ABSTRACT

An assembly for a vehicle, which includes two adjustment rails, arranged spaced apart and extending in parallel, for a seat of the vehicle and at least one transverse strut extending transversely to the adjustment rails, which rigidly connects the two adjustment rails to one another, as well as a body shell structure for a vehicle and a floor for a vehicle.

### FIELD

The invention relates to an assembly for a vehicle, which comprises two adjustment rails, arranged spaced apart and extending in parallel, for a seat of the vehicle and at least one transverse strut extending transversely to the adjustment rails, which rigidly connects the two adjustment rails to one another. Furthermore, the invention relates to a body shell structure for a vehicle and a floor for a vehicle.

### BACKGROUND

Arrangements having adjustable vehicle seats, i.e., vehicle seat arrangements are known in different embodiments. They usually comprise two or more adjustment rails, in which a vehicle seat, i.e., a seat of a vehicle designed to transport a person, is held adjustably.

For example, JP 2011 011 613 A discloses a vehicle rear bench arrangement which comprises four adjustment rails and a vehicle seat in the form of a vehicle rear bench having four seat interfaces which are held in the adjustment rails.

Another vehicle seat arrangement is disclosed in DE 10 2016 212 891 A1. The vehicle seat arrangement comprises three adjustment rails and a vehicle seat having three seat interfaces which are slidably held in the adjustment rails.

A structural complexity of vehicle seat arrangements is lower the fewer adjustment rails are provided per vehicle seat.

For example, JP H0481372 A discloses a body shell structure for a vehicle which comprises two pairs of adjustment rails, wherein each pair is assigned to one seat of the vehicle.

Only two adjustment rails are provided for each vehicle seat. However, the body shell structure as a whole has a high level of structural complexity, which is associated with complex manufacturing and high manufacturing costs.

### SUMMARY

The invention is therefore based on the object of providing an improved arrangement for a seat of a vehicle, which allows simple manufacturing of a load-bearing body shell structure. Further objects of the invention are to provide a body shell structure for a vehicle and a floor for a vehicle.

One subject matter of the invention is an assembly for a vehicle comprising two adjustment rails, arranged spaced apart and extending in parallel, for a seat of the vehicle and at least one transverse strut extending transversely to the adjustment rails, which rigidly connects the two adjustment rails to one another. The assembly is exclusively assigned to the seat. The adjustment rails are designed to slidably hold seat interfaces of the seat. Accordingly, the adjustment rails and the seat interfaces are designed corresponding to one another such that the seat interfaces cannot move transversely to the adjustment rails as a result of the seat interfaces engaging in the adjustment rails, and the seat interfaces can move along the adjustment rails. The adjustment rails can have a slot through which the seat interfaces extend when installed as intended.

According to the invention, the assembly consists of the two adjustment rails and the at least one transverse strut. Assemblies having exactly two adjustment rails are particularly preferred. The assembly does not comprise any other components and is a separate structural unit. Accordingly, the assembly can be manufactured separately and installed as a semi-finished product in a vehicle. The adjustment rails and the at least one transverse strut can be connected in a materially bonded manner, for example by means of a welded connection, or in a friction-locked manner, for example by means of a screw connection, or in a formfitting manner, for example by means of a latching connection. The adjustment rails are designed to absorb a longitudinal force acting on the assembly. The at least one transverse strut is designed to absorb a transverse force acting on the assembly. As a result, the assembly as a whole can absorb both longitudinal forces and transverse forces that act on the assembly. The longitudinal force and the transverse force can each act as a compressive force or a tensile force on the assembly. Absorbing a force is to be understood as dissipating the force without irreversible deformation. Thanks to the force absorption capacity, the assembly can have a stiffening, i.e., stabilizing function within a body shell structure of a vehicle.

Each adjustment rail advantageously comprises a hollow profile and/or has a rectangular cross section and/or has at least one beveled edge. A hollow profile has great stability and can absorb a large amount of force. The rectangular hollow profile is simple to produce and handle and can moreover absorb two mutually perpendicularly acting transverse forces, i.e., normal forces on two mutually perpendicular side faces of the hollow profile, particularly well. The beveled edge further improves the force absorption capacity of the hollow profile.

Each adjustment rail can be designed as a hollow profile or can comprise an outer hollow profile and an inner hollow profile arranged in the outer hollow profile. If the adjustment rail is designed as a hollow profile, i.e., comprises precisely one hollow profile, on the one hand, the at least one transverse strut is directly connected to the single hollow profile. On the other hand, the single hollow profile directly forms a linear guide for the seat interfaces. In this way, the adjustment rail has a particularly simple structure.

On the other hand, if the adjustment rail comprises an outer hollow profile and an inner hollow profile, on the one hand, the at least one transverse strut is directly connected to the outer hollow profile. On the other hand, the inner hollow profile forms the linear guide for the seat interfaces. Thanks to the two hollow profiles, the structural purpose of the adjustment track within the assembly and the functional purpose of the adjustment track with respect to the seat interfaces are sepa-rated from each other. In this way, a function of the adjustment rail is not impaired, for example, by a materially bonded connection, in particular a weld, of the adjustment rail to the at least one transverse strut.

It is apparent that in the case of two hollow profiles, both the outer hollow profile and the inner hollow profile each have corresponding slots when the seat interfaces engage through the adjustment rail in the installed state as intended. In particular, the outer hollow profile can be designed as a C-profile. An outer surface of the inner hollow profile can be in contact with an inner surface of the outer hollow profile. The inner hollow profile and the outer hollow profile can be connected in a formfitting, friction-locked, or materially-bonded manner, for example by means of corresponding contact surfaces.

It is preferred for the at least one transverse strut to be arranged between the two adjustment rails. In this way, the transverse strut sets a distance between the two adjustment rails which cor-responds to a length of the at least one transverse strut.

In many embodiments, the at least one transverse strut is designed as a hollow profile and/or each adjustment rail or the at least one transverse strut has a rectangular cross section and/or at least one beveled edge. A hollow profile has great stability and can absorb a large amount of force. The rectangular hollow profile is simple to produce and handle and can moreover absorb two mutually perpendicularly acting transverse forces, i.e., normal forces on two mutually perpendicular side faces of the hollow profile, particularly well. The beveled edge further improves the force absorption capacity of the hollow profile.

The assembly advantageously comprises a plurality of transverse struts. Thanks to the multiple transverse struts, the assembly can absorb an even greater transverse force. A single transverse strut can extend perpendicularly to the adjustment rails or obliquely, i.e., at an angle other than a right angle, to the adjustment rails. The plurality of transverse struts can comprise exclusively perpendicular, exclusively oblique, or both perpendicular and oblique transverse struts.

The transverse struts can be arranged equidistantly in relation to a longitudinal direction of the adjustment rails. Thanks to the equidistant arrangement, the force absorption capacity of the assembly for transverse forces is at least essentially homogeneous with respect to the longitudinal direction.

Furthermore, the at least one transverse strut or a plurality of transverse struts can be arranged centrally between the adjustment rails with respect to the longitudinal direction. The central arrangement results in a force absorption capacity of the assembly that is symmetrical with respect to the longitudinal direction.

The at least one transverse strut is advantageously aligned with each adjustment rail with respect to a direction perpendicular to the at least one transverse strut and the adjustment rail. In this way, the at least one transverse strut and the adjustment rails define a coherent flat contact surface, for example for a flat floor panel of a vehicle floor.

The assembly advantageously comprises at least one connecting strut protruding laterally from an adjustment rail. The at least one connecting strut increases a lateral extension of the assembly and a force transfer area of the assembly.

The at least one connecting strut can be designed as a hollow profile and/or have a rectangular cross section and/or have at least one beveled edge. The rectangular hollow profile is simple to produce and handle and can moreover absorb two mutually perpendicularly acting transverse forces, i.e., normal forces on two mutually perpendicular side faces of the hollow profile, particularly well. The beveled edge further improves the force absorption capacity of the hollow profile. In particular, the hollow profile of the at least one connecting strut and the hollow profile of the at least one transverse strut can have the same cross section and the same at least one beveled edge.

The at least one connecting strut is preferably aligned with the at least one transverse strut. In this way, the at least one connecting strut forms an outside continuation of the at least one inside transverse strut. Of course, two connecting struts arranged on opposite sides of the assembly can be aligned with the same transverse strut and continue the transverse strut on both outer sides. It is also understood that the assembly can comprise two connecting struts that continue the transverse strut laterally for each transverse strut.

Another subject matter of the invention is a body shell structure for a vehicle. The body shell structure can be designed as a chassis for a non-self-supporting body of the vehicle or a self-supporting body of the vehicle.

The body shell structure according to the invention has a receptacle for receiving an assembly according to the invention. The receptacle permits the assembly to be integrated into the body shell structure. The internal dimensions of the receptacle can correspond to the external dimensions of the assembly in order to enable the assembly to be integrated precisely fitted into the body shell structure. The assembly has a supporting function within the body shell structure, i.e., the assembly stabilizes or stiffens the body shell structure. As a result, the body shell structure can be dimensioned smaller, which is accompanied by a lower weight of the body shell structure and therefore of the vehicle.

Another subject matter of the invention is a floor for a vehicle. The floor delimits an interior space of the vehicle at an underside of the vehicle. Every vehicle intended to transport people comprises a floor which supports people being transported. Accordingly, there are many possibil-ities for applying the invention. The underside of the vehicle faces toward an underlying surface that supports the vehicle against the weight of the vehicle.

The floor according to the invention comprises a body shell structure according to the invention, an assembly according to the invention arranged in the receptacle of the body shell structure, and a flat floor panel, which is arranged on a side of the body shell structure facing towards an interior of the vehicle. The flat floor plate has two slots which, when the floor is installed as intended, are each aligned with a slot of an adjustment rail, so that the slots which are aligned with one another are each jointly penetrated by a seat interface.

The adjustment rails and the at least one transverse strut of the assembly are arranged on a side of the flat floor panel facing away from an interior of the vehicle. Accordingly, no interfering edge protrudes from the floor of the vehicle. Apart from that, installation space is saved in the interior of the vehicle, which would otherwise be required by the adjustment rails and possibly the at least one transverse strut.

The assembly integrated into the body shell structure has a supporting function within the body shell structure and increases a rigidity, i.e., stability, of the body shell structure and thus of the vehicle floor. Accordingly, the body shell structure can be dimensioned smaller, which reduces a weight of the vehicle.

In many embodiments, the flat floor plate is in contact with the body shell structure or the assembly. The flat floor plate further increases the stability, i.e., the rigidity, of the body shell structure and thus of the vehicle floor. The flat floor plate can be connected to the shell structure or the assembly in a materially bonded, friction-locked, or formfitting manner

One essential advantage of the assembly according to the invention is that the adjustment rails and transverse struts also assume a supporting function, i.e., increase the stability of the vehicle floor. As a result, a body shell structure of the vehicle can be lighter and a weight of the vehicle can be less, which is accompanied by lower fuel consumption and better economy of the vehicle. It is also advantageous that neither the adjustment rails nor the transverse struts protrude from the vehicle floor. On the one hand, this eliminates irritating edges, which reduces an irritating edge for people in the interior of the vehicle. On the other hand, an installation space in the interior of the vehicle is increased or the height of the vehicle is reduced with the same installation space in the interior of the vehicle, which has a favorable effect on the cost-effectiveness of the vehicle.

### BRIEF DESCRIPTION OF THE FIGURES

The invention is schematically illustrated in the drawings with the aid of embodiments and is described further with reference to the drawings. In the figures:

FIG. 1 shows a perspective view of an assembly according to a first embodiment of the invention;

FIG. 2 shows a perspective view of the assembly shown in FIG. 1 having a floor plate and two seat interfaces held slidably in the adjustment rails;

FIG. 3 shows a cross-sectional view of a floor according to the first embodiment of the invention;

FIG. 4 shows a perspective view of an assembly according to a second embodiment of the invention;

FIG. 5 shows a cross-sectional view of a floor according to the second embodiment of the invention;

FIG. 6 shows an enlarged detail of the assembly shown in FIG. 4 in a cross-sectional view.

Corresponding features are provided with identical reference symbols in the figures.

### DETAILED DESCRIPTION

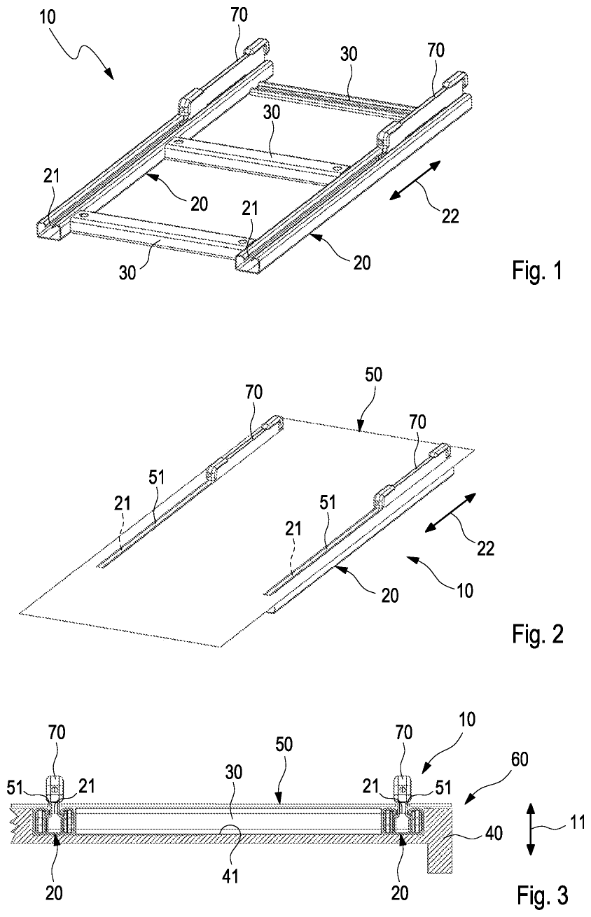

FIG. 1 shows a perspective view of an assembly 10 according to a first embodiment of the invention. The assembly 10 is suitable for installation in a vehicle, more precisely in a body shell structure of a floor of the vehicle, and consists of two adjustment rails 20 and at least one transverse strut 30.

The two adjustment rails 20 are suitable for a seat (not shown) of the vehicle known per se and are arranged at a distance from one another and extend in parallel. Each adjustment rail 20 is designed as a hollow profile and has a rectangular cross section and at least one beveled edge and a slot 21 through which a seat interface 70 can engage.

The at least one transverse strut 30 extends transversely to the adjustment rails 20 and rigidly connects the two adjustment rails 20 to one another. The at least one transverse strut 30 is designed as a hollow profile and has a rectangular cross section and at least one beveled edge. The at least one transverse strut 30 is arranged between the two adjustment rails 20.

The assembly 10 comprises a plurality of transverse struts 30, three transverse struts 30 here merely by way of example and not restrictively. The transverse struts 30 are arranged equidistantly in relation to a longitudinal direction 22 of the adjustment rails 20 and are arranged centrally between the adjustment rails 20 in relation to a longitudinal direction 22 of the adjustment rails 20.

FIG. 2 shows a perspective view of the assembly 10 shown in FIG. 1 having a floor plate 50 and two seat interfaces 70 held slidably in the adjustment rails 20. The floor plate 50 is flat and has two slots 51 through which the seat interfaces 70 can pass, and each of which aligns with one slot 21 of an adjustment rail 20.

FIG. 3 shows a cross-sectional view of a floor 60 according to the first embodiment of the invention; The floor 60 comprises a body shell structure 40 having a receptacle 41 for receiving the assembly 10, i.e., the adjustment rails 20 and the transverse struts 30, and the assembly 10, which is arranged in the receptacle 41 of the body shell structure 40. Furthermore, the floor 60 comprises the flat floor plate 50 which is arranged on a side of the body shell structure 40 facing toward an interior of the vehicle.

The at least one transverse strut 30 is aligned with each adjustment rail 20 with respect to a Z-direction 11 of the assembly 10, which is perpendicular to the at least one transverse strut 30 and the adjustment rail 20. The assembly 10 is aligned in relation to the Z-direction 11 with the body shell structure 40. The flat floor plate 50 is in contact with the body shell structure 40 and the assembly 10.

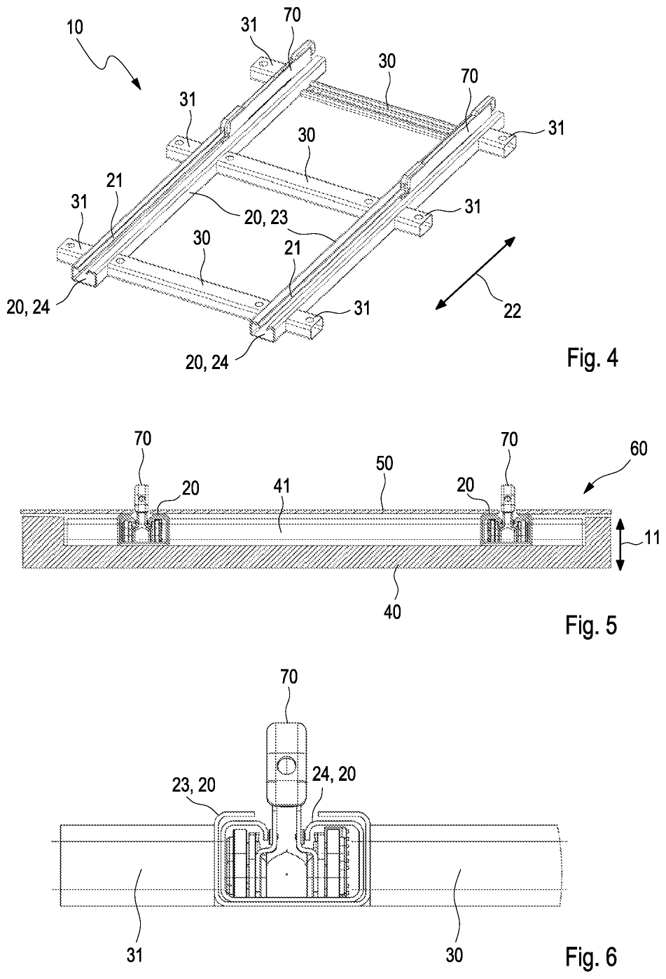

FIG. 4 shows a perspective view of an assembly 10 according to a second embodiment of the invention. The assembly 10 is suitable for installation in a vehicle, more precisely in a body shell structure of a floor of the vehicle, and consists of two adjustment rails 20 and at least one transverse strut 30.

The two adjustment rails 20 are suitable for a seat (not shown) of the vehicle known per se and are arranged at a distance from one another and extend in parallel. Each adjustment rail 20 comprises a hollow profile, more precisely an outer hollow profile 23 and an inner hollow profile 24 arranged in the outer hollow profile 23. Each adjustment rail 20, i.e., in each case the outer hollow profile 23 and the inner hollow profile 24, has a rectangular cross section and at least one beveled edge and a slot 21 through which a seat interface 70 can engage.

The at least one transverse strut 30 extends transversely to the adjustment rails 20 and rigidly connects the two adjustment rails 20 to one another. The at least one transverse strut 30 is designed as a hollow profile and has a rectangular cross section and at least one beveled edge. The at least one transverse strut 30 is arranged between the two adjustment rails 20.

The assembly 10 comprises a plurality of transverse struts 30, three transverse struts 30 here merely by way of example and not restrictively. The transverse struts 30 are arranged equidistantly in relation to a longitudinal direction 22 of the adjustment rails 20 and are arranged centrally between the adjustment rails 20 in relation to a longitudinal direction 22 of the adjustment rails 20.

Furthermore, the assembly 10 comprises at least one connecting strut 31 protruding laterally from an adjustment rail 30, six connecting struts 31 here merely by way of example and not restrictively. The at least one connecting strut 31 is designed as a hollow profile and has a rectangular cross section and at least one beveled edge. The at least one connecting strut 31 is aligned with a transverse strut 30. Specifically, two connecting struts 31 arranged on opposite sides of the assembly 10 are aligned with the same transverse strut 30.

FIG. 5 shows a cross-sectional view of a floor according to the second embodiment of the invention; The floor 60 comprises a body shell structure 40 having a receptacle 41 for receiving the assembly 10, i.e., the adjustment rails 20, the transverse struts 30, and the connecting struts 31, and the assembly 10, which is arranged in the receptacle 41 of the body shell structure 40. Furthermore, the floor 60 comprises the flat floor plate 50 which is arranged on a side of the body shell structure 40 facing toward an interior of the vehicle.

The at least one transverse strut 30 and the at least one connecting strut 31 are aligned with each adjustment rail 20 with respect to a Z-direction 11 of the assembly 10, which is perpendicular to the at least one transverse strut 30 and the adjustment rail 20. The assembly 10 is aligned with respect to the Z-direction 11 with the body shell structure 40. The flat floor plate 50 is in contact with the body shell structure 40 and the assembly 10.

FIG. 6 shows an enlarged detail of the assembly 10 shown in FIG. 4 in a cross-sectional view. The outer hollow profile 23 of the adjustment rail 20 is designed as a C-profile. The inner hollow profile 24 of the adjustment rail 20 is designed as a C-profile, wherein the opposite free ends of the C-profile are bent inward. The transverse strut 30 and the connecting strut 31 are arranged on opposite sides of the adjustment rail 20.

The transverse strut 30 and the connecting strut 31 are exclusively connected to the outer hollow profile 23 of the adjustment rail 20. The seat interface 70 is exclusively in contact with the inner hollow profile 24 of the adjustment rail 20. An inner surface of the outer hollow profile 23 is in contact with an outer surface of the inner hollow profile 24. The outer hollow profile 23 and the inner hollow profile 24 are rigidly connected.

It is apparent that the arrangement shown in FIG. 2 can be formed analogously with the assembly 10 shown in FIG. 4. It is also to be noted that the at least one connecting strut 31 and the adjustment rail 20 comprising the outer hollow profile 23 and the inner hollow profile 24 are com-bined in the second embodiment only by way of example. Other embodiments of the present invention can have exclusively the former or exclusively the latter.

### LIST OF REFERENCE SIGNS

10 assembly
11 Z-direction
20 adjustment rail
21 slot
22 longitudinal direction
23 outer hollow profile
24 inner hollow profile
30 transverse strut
31 connecting strut
40 body shell structure
41 receptacle
50 floor plate
51 slot
60 floor
70 seat interface

1-10. (canceled)

11. An assembly for a vehicle, comprising two adjustment rails, arranged spaced apart and extending in parallel, for a seat of the vehicle and at least one transverse strut extending transversely to the adjustment rails, which strut rigidly connects the two adjustment rails to one another.

12. The assembly as claimed in claim 11, in which each adjustment rail comprises a hollow profile and/or has a rectangular cross-section and/or has at least one beveled edge.

13. The assembly as claimed in claim 11, in which each adjusting rail is designed as a hollow profile or comprises an outer hollow profile and an inner hollow profile arranged in the outer hollow profile.

14. The assembly as claimed in claim 11, in which the at least one transverse strut is arranged between the two adjustment rails and/or is designed as a hollow profile and/or has a rectangular cross section and/or has at least one beveled edge.

15. The assembly as claimed in claim 11, having a plurality of trans-verse struts.

16. The assembly as claimed in claim 15, wherein the transverse struts are arranged equidistantly with respect to a longitudinal direction of the adjustment rails and/or the at least one transverse strut or a plurality of transverse struts is arranged centrally between the adjustment rails with respect to a longitudinal di-rection of the adjustment rails and/or the at least one transverse strut is aligned with each adjustment rail with respect to a Z-direction of the assembly perpendicular to the at least one transverse strut and the adjustment rail.

17. The assembly as claimed in claim 11, having at least one connecting strut projecting laterally outwards from an adjustment rail.

18. A body shell structure for a vehicle, having a receptacle for receiving an assembly as claimed in claim 11.

19. A floor for a vehicle, having a body shell structure as claimed in claim 18 arranged in the receptacle of the body shell structure, and a flat floor plate, which is arranged on a side of the body shell structure facing toward an interior of the vehicle.

20. The floor as claimed in claim 19, in which the flat floor panel is in contact with the body shell structure or the assembly.

21. The assembly as claimed in claim 12, in which each adjusting rail is designed as a hollow profile or comprises an outer hollow profile and an inner hollow profile arranged in the outer hollow profile.

22. The assembly as claimed in claim 12, in which the at least one transverse strut is arranged between the two adjustment rails and/or is designed as a hollow profile and/or has a rectangular cross section and/or has at least one beveled edge.

23. The assembly as claimed in claim 13, in which the at least one transverse strut is arranged between the two adjustment rails and/or is designed as a hollow profile and/or has a rectangular cross section and/or has at least one beveled edge.

24. The assembly as claimed in claim 12, having a plurality of trans-verse struts.

25. The assembly as claimed in claim 13, having a plurality of trans-verse struts.

26. The assembly as claimed in claim 14, having a plurality of trans-verse struts.

27. The assembly as claimed in claim 12, having at least one connecting strut projecting laterally outwards from an adjustment rail.

28. The assembly as claimed in claim 13, having at least one connecting strut projecting laterally outwards from an adjustment rail.

29. The assembly as claimed in claim 14, having at least one connecting strut projecting laterally outwards from an adjustment rail.

30. The assembly as claimed in claim 15, having at least one connecting strut projecting laterally outwards from an adjustment rail.
